(19) United States
(12) Patent Application Publication
(10) Pub. No.: US 2019/0333134 A1
(43) Pub. Date: Oct. 31, 2019

(54) SEATING DISPLAY METHOD, DEVICE AND EQUIPMENT

(71) Applicant: Alibaba Group Holding Limited, Georgetown (KY)

(72) Inventor: Chungang DING, Beijing (CN)

(21) Appl. No.: 16/395,913

(22) Filed: Apr. 26, 2019

(30) Foreign Application Priority Data
Apr. 28, 2018 (CN) 201810403661.7

(51) Int. Cl. G06Q 30/06; G06Q 10/02

(52) U.S. Cl. CPC G06Q 30/0641; G06Q 10/02

(57) ABSTRACT

A computer implemented seating display method, device and apparatus, the method comprising: providing a seat display interface, displaying a target site in a planar display mode; receiving a cut face viewing operation performed by a user on the seat display interface, displaying a plurality of cut faces of the target site in a cut face browsing mode for the user to browse and select a cut surface of the target site; receiving a cut face selecting operation performed by the user on the seat display interface, displaying a corresponding cut face of the target site in the cut face display mode for displaying a corresponding seat layout following the operation of the user. By the present invention, a three-dimensional spatial layout of a target site can be quickly and intuitively displayed in a two-dimensional planar form, such that the seat layout is visualized to enhance users' experience.

### PRIORITY CLAIM

This patent application claims priority to China Patent Application No. 201810403661.7 filed Apr. 28, 2018 herein incorporated by reference in its entirety.

### TECHNICAL FIELD

The present invention relates to the field of computer technology; in particular, a computer implemented seating display method, device and equipment.

### BACKGROUND

With the rapid development of computer technology and the increasing popularity of networks, users can access many life services online to improve their quality of life. For example, online users can order seating tickets for a performance, seating tickets for a movie, reserve restaurant seats, select transportation vehicle seats and the like, through the Internet without waiting in a waiting line on the site to purchase the seat tickets, which brings great convenience to the users.

A ticketing service that provides online ticket purchasing or reservations typically shows the corresponding seating map or layout through an application interface, for users to select seats online before purchasing seat tickets. However, due to the limited front-end performance of current ticketing applications, for online selection of seats, only a two-dimensional planar seat layout can be shown to users. For large sites or venues with multi-story spaces (such as a large stadium), the seating spatial or three-dimensional location information (such as floor, seat height and the like) in the site or venue is provided only by descriptive text. Accordingly, the spatial or three-dimensional positions of seats cannot be visually displayed, and visibility of seat display is poor, which affects users' experience.

### SUMMARY

In various embodiments, the present invention provides for a new technical solution for seating display.

According to a first aspect of the present invention, the present invention provides a computer implemented seating display method, wherein the method comprises:
providing a seat display interface and displaying a target site in a planar display mode;
receiving a cut face viewing operation performed by a user on the seat display interface, and displaying a plurality of site cut faces of the target site in a cut face browsing mode for the user to browse and select a target site cut face;
wherein the site cut face is a two-dimensional plane obtained by means of cutting a site three-dimensional view of a corresponding site;
receiving a cut face selecting operation performed by the user on the seat display interface, displaying a corresponding target site cut face in the cut face display mode for displaying a corresponding seat layout following the operation of the user.

In another embodiment, the method further comprises a step of obtaining the site cut face of the target site:
obtaining a site three-dimensional view of the target site;
according to a preset cutting rule, cutting the site three-dimensional view to obtain a plurality of candidate site cut faces;
selecting candidate site cut faces that meet a preset effective cut face condition, so as to obtain the plurality of site cut faces of the target site.

In another embodiment, the cutting rule is to cut a corresponding three-dimensional view into a predetermined number of cut faces at equal intervals in a specific dimension direction;
the effective cut face condition is that the candidate site cut faces comprise at least one site element different from the other candidate site cut faces, and the site element comprises at least one of a floor, a stand, and a stage; and/or,
the step of obtaining the site cut faces of the target site further comprises:
   generating a corresponding site cut face linked list according to a relative spatial position of each of the site cut faces in the target site;
   wherein the site cut face linked list comprises a linked list order of each of the site cut faces, and the linked list order corresponds to the relative spatial position.

In another embodiment, the step of displaying the plurality of site cut faces of the target site in a cut face browsing mode comprises:
displaying the site cut faces associated with the cut face viewing operation through the seat display interface;
providing a cut face viewing control element through the seat display interface to receive the cut face browsing operation; and
locating a site cut face corresponding to the cut face viewing operation, when the located site cut face is inconsistent with the site cut face displayed by the current seat display interface, switching to display the located site cut face.

In another embodiment, the cut face viewing control element comprises a cut face selection control element, and the cut face selection control element is set according to the acquired site cut face linked list, wherein the site cut face linked list comprises the linked list order of each of the site cut faces, and the linked list order corresponds to the relative spatial position of the site cut face in the corresponding site;
the step of locating the site cut face corresponding to the cut face browsing operation comprises:
locating in the site switch linked list to obtain the corresponding site cut face according to the linked list order corresponding to the operation position of the cut face browsing operation on the cut face selection control element.

In another embodiment, the method further comprises: when the cut face browsing operation ends on the cut face selection control element, locating in the site switch linked list to obtain the corresponding target site cut face according to the linked list order corresponding to the operation position at the operation end, and entering the cut face display mode.

In another embodiment, when the cut face browsing operation ends on the cut face selection control element, locating in the site switch linked list to obtain the corresponding target site cut face according to the linked list order corresponding to the operation position at the operation end, and entering the cut face display mode.

In another embodiment, the planar display mode is to display the site elements included in the corresponding planar space in the planar view mode, the site element comprises at least one of a floor, a stand, and a stage; the cut face browsing mode is to display the site elements included in the plurality of site cut faces in a planar view form in a rotating manner; and the cut face display mode is to display the site elements included in the target site cut face in a planar view form; and/or the cut face viewing operation is a moving operation performed on a cut face viewing control element provided by the seat display interface.

According to another aspect of the present invention, the present invention provides a seat display device, wherein the device comprises:
an interface providing unit for providing a seating display interface and displaying a target site in a planar display mode;
a cut face browsing unit for receiving a cut face viewing operation performed by a user on the seating display interface, and displaying a plurality of site cut faces included in a target site in the cut face browsing mode for the user to browse and select a target site cut face;
wherein the site cut face is a two-dimensional plane obtained by dividing a three-dimensional view of a corresponding site; and
a cut face selecting unit for receiving a cut face selection operation performed by a user on the seat display interface, and displaying a corresponding target site cut face in a cut face display mode, so as to display a corresponding seat layout after the user performing the operation.

According to another aspect of the present invention, the present invention provides an electronic device, wherein the device comprises:
a display device for displaying a human machine interaction interface;
a memory for storing an executable instruction;
a processor for operating the electronic device to perform the seat display method according to any item of the first aspect of the present invention according to the control of the executable instruction.

According to an embodiment of the present invention, a plurality of site cut faces included in the target site are displayed through the seating display interface, so that the user can browse and select the target site cut face that meets the user's requirement. The corresponding seating layout is displayed for the user to select. In this way, in the case where the display is limited, the three-dimensional spatial layout of the target site is quickly and intuitively displayed to the use in the form of a two-dimensional plane, so that the three-dimensional spatial dimension information of the target site is visualized, the visibility of the seat display is optimized, and the user experience is improved.

Other features and advantages of the invention will be apparent in the following detailed description of exemplary embodiments of the present invention, with reference to the following drawings.

### BRIEF DESCRIPTION OF DRAWINGS

The accompanying drawings show embodiments of the present invention. Together with the brief description, the drawings are used to explain the present invention.

FIG. 1 is a block diagram showing an example of a hardware configuration of a computing system that can be used to implement the embodiments of the present invention.

FIG. 2 is a flow chart of the seat display method of an embodiment of the present invention.

FIG. 3 is a flow chart showing the steps of acquiring a site cut face in accordance with an embodiment of the present invention.

FIG. 4 is a flow chart showing an example of acquiring a site cut face in accordance with an embodiment of the present invention.

FIG. 5 is a flow chart of an example of the seat display method of an embodiment of the present invention.

FIG. 6 is a flow chart showing the steps of displaying a site cut face in accordance with an embodiment of the present invention.

FIG. 7 is a flow chart showing the steps of displaying seat layout in accordance with an embodiment of the present invention.

FIG. 8 is a block diagram of a seat display device of an embodiment of the present invention.

FIG. 9 is a block diagram of an electronic device of an embodiment of the present invention.

### DETAILED DESCRIPTION

### Embodiments

Various exemplary embodiments of the present invention are described in detail with reference to the accompanying drawings. It should be noted that the relative arrangement of the components and steps, numerical expressions and numerical values set forth in the examples are not intended to limit the scope of the present invention unless otherwise specified.

The following description of exemplary embodiments is merely descriptive in nature, and does not limit the present invention and an application or use thereof. Techniques, methods, and devices known to a person of ordinary skill in the relevant art may not be discussed in detail herein. However, where appropriate, the techniques, methods and equipment should be considered as parts of the description of the present application. In all of the examples shown and discussed herein, any specific values are to be construed as illustrative only and not as a limitation. Thus, other examples of the exemplary embodiments may have different values. It should be noted that similar reference numerals and letters indicate similar items in the following figures, and therefore, once an item is defined in one figure, it does not need to be further discussed in the subsequent figures.

### Hardware Configuration

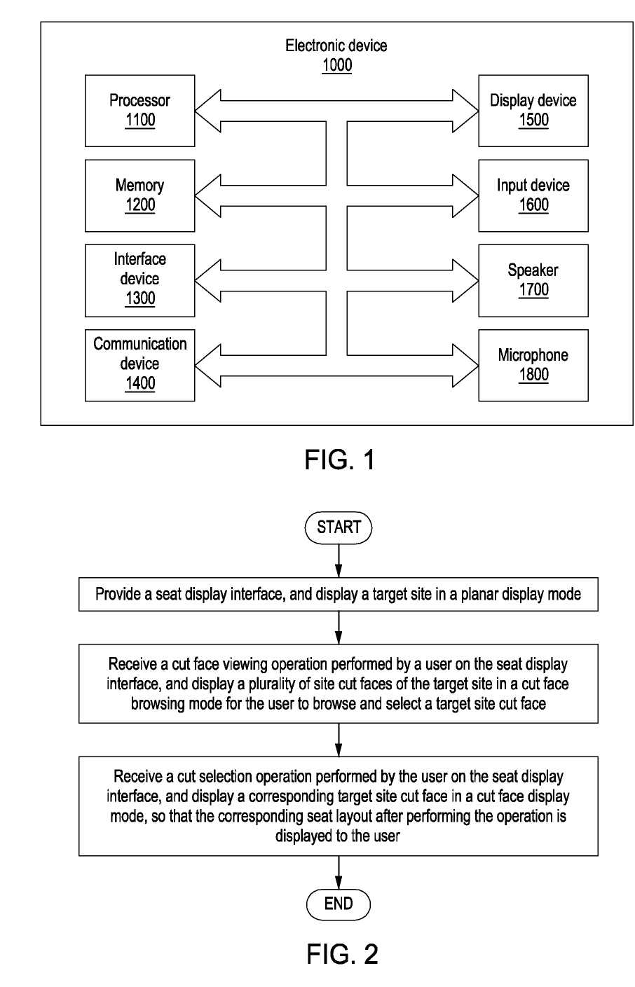

FIG. 1 is a block diagram showing a hardware configuration of an electronic device 1000 in which an embodiment of the present invention can be implemented. The electronic device 1000 can be a portable computer, a desktop computer, a mobile phone, a tablet, and the like. As shown in FIG. 1, the electronic device 1000 may include a processor 1100, a memory 1200, an interface device 1300, a communication device 1400, a display device 1500, an input device 1600, a speaker 1700, a microphone 1800, and the like.

The processor 1100 may be a central processing unit CPU, a microprocessor MCU, or the like. The memory 1200 may include, for example, a ROM (Read Only Memory), a RAM (Random Access Memory), a nonvolatile memory such as a hard disk, and the like.

The interface device 1300 includes, for example, a USB interface, a headphone jack, and the like. The communication device 1400 can, for example, perform wired or wireless communication, and specifically can include Wi-Fi communication, Bluetooth communication, 2G/3G/4G/5G communication, and the like. The display device 1500 is, for example, a liquid crystal display, a touch display, or the like.

Input device 1600 can include, for example, a touch screen, a keyboard, a somatosensory input, and the like. The user can input/output voice information through the speaker 1700 and the microphone 1800.

The electronic device shown in FIG. 1 is merely for the purpose of illustration, rather than for limiting the present invention, its application or use. In an embodiment of the present invention, the memory 1200 of the electronic device 1000 is configured to store instructions for controlling the processor 1100 to operate so as to perform any of the seat display methods provided by the embodiments of the present invention. It will be understood by a person skilled in the art that although a plurality of devices are illustrated for the electronic device 1000 in FIG. 1, the present invention may relate only to some of the devices, for example, the electronic device 1000 may relate only to a processor 1100 and a storage device 1200. One skilled in the art can design instructions in accordance with the disclosed solutions of the present invention. How the instructions control the processor for operation is well known in the art and will not be described in detail herein.

### EXAMPLES

### Method

In this example, a seating display method is provided. The seating is a resource that a user can select or reserve online through the Internet, including a seat for a performance, a seat for a movie, a seat at a restaurant, a seat on a vehicle, and the like.

The seating display method is as shown in FIG. 2, and includes: steps S2100 to S2300.

Step S2100, providing a seat display interface, and displaying a target site in a planar display mode.

The seating display interface is an application interface that displays the seats available for online selection and receives a user operation to provide a corresponding human machine interaction service; it can be presented by the display device of the electronic device of the example.

A target site is a site of the seats that a user wants to select online, it has a corresponding geographical location and physical space, and for example, it may be a gymnasium, a movie theater, a theater, and the like.

A planar display mode refers to a display mode in which the target site is displayed in a planar view. In one example, the planar display mode is a floor plan showing the site elements included in the corresponding planar space. The site elements include at least one of a floor, a stand, and a stage.

Displaying the target site through the planar display mode allows the user to observe the overall spatial layout of the target site as a whole.

Step S2200, receiving a cut face or cross-section viewing operation performed by a user on the seat display interface, and displaying a plurality of site cut faces of the target site in a cut face browsing mode for the user to browse and select a target site cut face;
wherein the site cut face is a two-dimensional plane obtained by means of cutting a site three-dimensional view of a corresponding site.

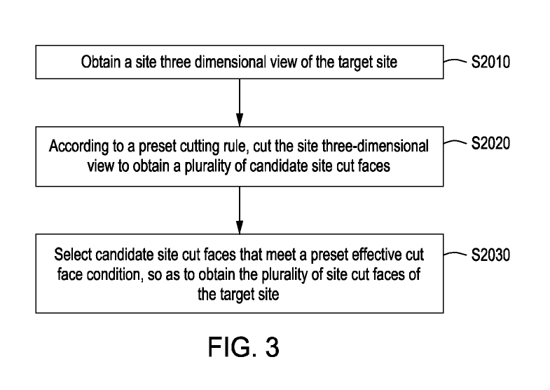

In one example, the seat display method provided in this example further includes a step of acquiring a site cut face of the target site, as shown in FIG. 3, including: steps S2010-S2030.

Step S2010, obtaining a site three dimensional view of the target site.

A site three dimensional view of the target site is a three-dimensional graph or model that visually reflects the physical space layout of the target site, it may be pre-existing in the storage device of a local or remote server of the electronic device that implements an embodiment of the present invention, and may be requested by reading the memory or requesting the remote server.

Step S2020, according to a preset cutting rule, cutting the site three-dimensional view to obtain a plurality of candidate site cut faces.

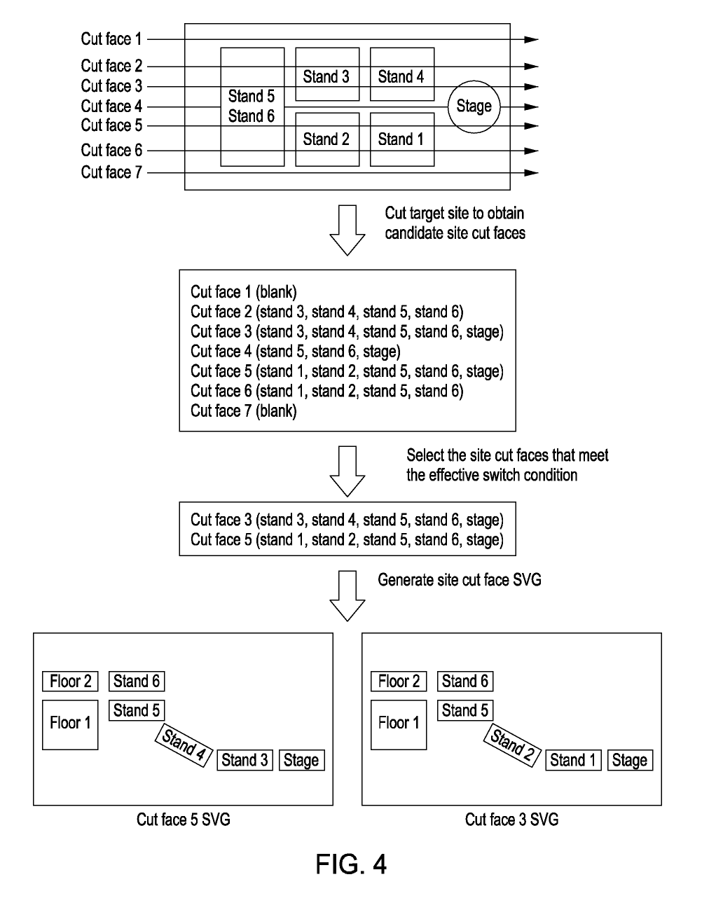

In this example, the cutting rule may be set according to an actual application scenario or application requirement. For example, taking the three-dimensional view of the site shown in FIG. 4 as an example (due to the display limitation, only the planar view of two dimensions of the three-dimensional view can be shown in FIG. 4), seven candidate site cut faces can be obtained through cuttings: from cut face 1 to cut face 7.

In another example, the cutting rule is to divide the corresponding three-dimensional view into a predetermined number of cut faces at equal intervals in a specific dimension direction. The specific dimension direction may be any one of the three dimensions, and the predetermined number may be set according to a specific application scenario or application requirement.

Step S2030, selecting candidate site cut faces that meet a preset effective cut face condition, so as to obtain the plurality of site cut faces of the target site.

The effective cut face condition can be set according to a specific application scenario or application requirement. For example, the effective cut face condition is that the candidate site cut faces comprise at least one site element different from the other candidate site cut faces, and the site element comprises at least one of a floor, a stand, and a stage.

Taking the candidate site cut faces (cut face 1 to cut face 7) shown in FIG. 4 as an example, the site cut faces that meet the effective section condition which are selected include: cut face 3 and cut face 5. In this example, the step of obtaining the site cut faces of the target site further comprises:
generating a corresponding site cut face linked list according to a relative spatial position of each of the site cut faces in the target site;
wherein the site cut face linked list comprises a linked list order of each of the site cut face, and the linked list order corresponds to the relative spatial position.

For example, taking the target site shown in FIG. 4 as an example, after obtaining the cut faces that meet the effective cut face condition (cut face 3, cut face 5), the SVG (Scalable Vector Graphics) of the cut face 3 and the cut face 5 may be separately generated. In the “SVG of cut face 3” and the “SVG of cut face 5,” the site elements such as the floor and the stand have corresponding graphics, and these graphics are all independent SVG elements. Then, according to the actual relative spatial position of the cut face 3 and the cut face 5 in the corresponding target site (for example, the actual spatial distance, etc.), the corresponding linked list orders can be obtained, and a site cut face linked list is generated. In addition, in this example, it is assumed that the target site is a circular stadium, which can be connected by the cut face SVGs at the head and the tail of the site cut face linked list, so that the site cut face linked list forms a circular two directional linked list.

In this example, the cut face viewing operation is a human machine interaction operation implemented on the seat display interface, and can be set according to a specific application scenario or application requirement. For example, the cut face viewing operation can be a moving operation performed on a cut face viewing control element provided by the seat display interface.

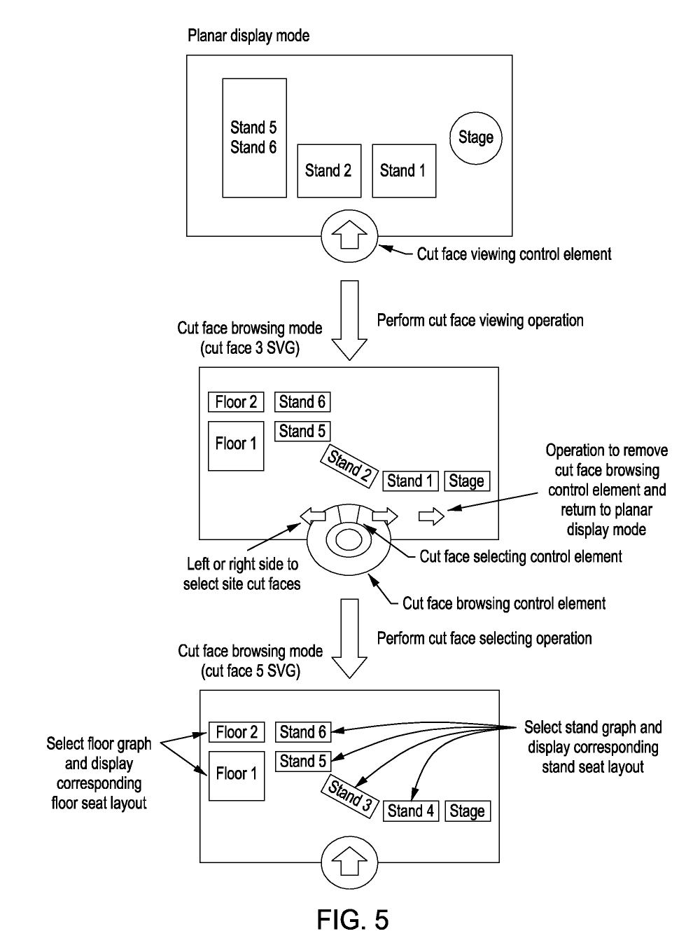

The cut face viewing control element is an interface control element that is set on the seat display interface for a user to operate to obtain a corresponding function. Specifically, as shown in FIG. 5, cut face viewing control element may be an arrow control element disposed below the seat display interface in the planar display mode, and may be selected and then operated by a user to move toward the direction of the arrow, and the cut face viewing operation can be set to be an operation in which the distance of moving the arrow control element is greater than a preset distance threshold. When the user implements an operation of the arrow control element that complies with the cut face viewing operation, an access to the cut face browsing mode is triggered.

In this example, the cut face browsing mode is a display mode in which a plurality of site cut faces of the target site are displayed in the form of a planar view. For example, the cut face browsing mode is to display the site elements included in the plurality of site cut faces in a planar view form in a rotating manner. Specifically, in the cut face browsing mode, the displayed site cut face may be a corresponding cut face SVG, and the cut surface SVG displays the site element graphics included in each corresponding site cut face, and each site element graphic is an independent SVG element.

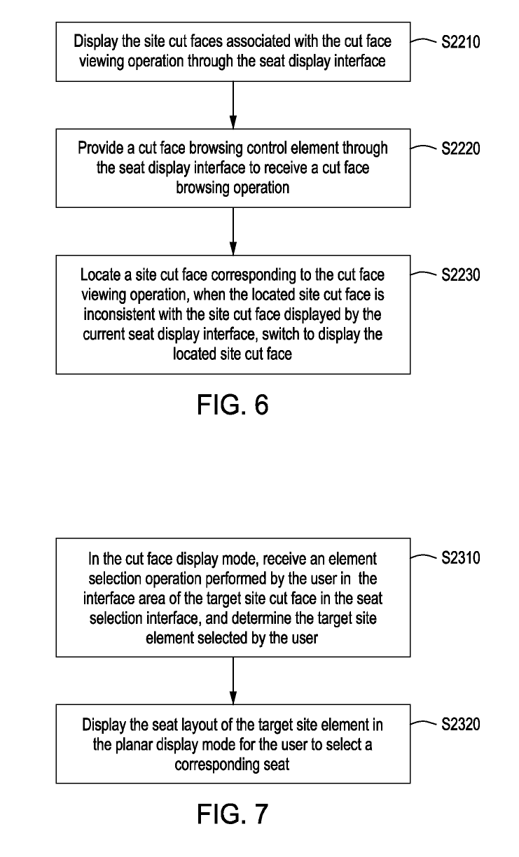

In one example, the step of displaying the plurality of site cut faces included in the target site in a cut face browsing mode may be as shown in FIG. 6, including the Steps S2210-S2230.

Step S2210, displaying the site cut faces associated with the cut face viewing operation through the seat display interface.

The cut face viewing operation is an interface operation that triggers the entry into the cut face browsing mode. The site cut faces associated with the cut face viewing operation can be determined according to a preset association rule. The association rule can be set according to a specific application scenario or application requirement. For example, taking FIG. 5 as an example, the cut face viewing operation may be a moving operation performed by a user on the cut face viewing control element provided by the seat display interface, and may be set to be a site cut face corresponding to the coordinate position of the cut face viewing operation in the planar display mode, and having the closest actual spatial position in the target site. Alternatively, it may also be the site cut face in which the site element closest to the user's actual entry into the target site is located.

In this example, when the user's cut face browsing operation ends in an interface area beyond the cut face browsing control element, it will trigger to return to the planar display mode to display the target site. For example, when the user's finger or other operating tool moves to an interface area beyond the cut face browsing control element, it will return to the planar display mode to display the target site.

Step S2220, providing a cut face browsing control element through the seat display interface to receive a cut face browsing operation.

The cut face browsing control element is an interface control element that is provided on the seat display interface for the user to operate to obtain a corresponding function. For example, the cut face browsing control element can be a circular control element provided below the seat display interface in the cut face browsing mode, as shown in FIG. 5.

The cut face browsing control element may comprise a cut face selection control element, and the cut face selection control element is set according to the acquired site cut face linked list. The site cut face linked list comprises the linked list order of each of the site cut faces, and the linked list order corresponds to the relative spatial position of the site cut face in the corresponding site. For example, in FIG. 5, the cut face browsing control element is the entire circular control element, while the cut face selection control element is a circle-shaped part control element of the cut face browsing control element. In the cut face selection control element, lines are used to identify the corresponding site cut faces on the circle part control element according to the linked list order (corresponding to the relative spatial position in the actual target site) of the site cut faces in the site cut face linked list. FIG. 5 shows the site cut faces (cut face 3, cut face 5) obtained by cutting the target site in the example shown in FIG. 4, and the cut face 3 and the cut face 5 are respectively identified by two lines on the circle part, and the cut face browsing operation is set to be the operation having its operation position in the position of the lines.

Step S2230, locating a site cut face corresponding to the cut face viewing operation, when the located site cut face is inconsistent with the site cut face displayed by the current seat display interface, switching to display the located site cut face.

For example, the cut face selection control element can also include a cut face selection control element. Correspondingly, the step of locating the site cut face corresponding to the cut face browsing operation comprises: locating in the site switch linked list to obtain the corresponding site cut face according to the linked list order corresponding to the operation position of the cut face browsing operation on the cut face selection control element.

Specifically, taking the case shown in FIG. 5 as an example, in the cut face browsing mode, a user can select the site cut faces to be browsed by means of performing a cut face browsing operation such as making a left or right slide on the cut face selection control element. In addition, when the operation position of the user's cut face browsing operation falls on the position of a line on the cut face selection control element, the linked list order corresponding to the position of the line can be obtained, and in turn locating in the corresponding site switch linked list to obtain the corresponding site cut face.

For example, the SVG of the cut face 3 is currently displayed, while the site cut face obtained in the locating which is corresponding to the cut face browsing operation is the cut face 5, it will switch to display the SVG of the cut face 5, as shown in FIG. 5. In this example, after switching to display the site cut face for cut face browsing, the method further comprises: when the cut face browsing operation ends on the cut face selection control element, locating in the site switch linked list to obtain the corresponding target site cut face according to the linked list order corresponding to the operation position at the operation end, and entering the cut face display mode.

Using the case shown in FIG. 5 as an example, when the user's cut face browsing operation (finger sliding operation) falls in the position of the line on the cut face selection control element in a circle shape, switches to display the SVG of the cut face 5, and when the user's cut face browsing operation ends at the line position (the finger leaves the interface), enters the cut face display mode.

In step S2200, through the cut face browsing mode, a user can browse a plurality of site cut faces obtained by cutting the site three-dimensional view of the target site. In this way, when the display performance is limited, a two-dimensional planar form is used to quickly and intuitively display the three-dimensional spatial layout of the target site, so that the three-dimensional space of the target site becomes viewable in a planar mode, which allows the user to intuitively select the site cut face that meets the specific spatial requirement.

Step S2300, receive a cut selection operation performed by the user on the seat display interface, and display a corresponding target site cut face in a cut face display mode, so that the corresponding seat layout after performing the operation is displayed to the user.

The planar display mode is to display the site elements included in the corresponding planar space in the planar view mode. For example, the cut face display mode is to display the site elements included in the target site cut face in the planar view mode. The site elements include at least one of a floor, a stand, and a stage. Specifically, in the cut face display mode, the SVG of the target site cut face is displayed, and the SVG displays a graphic of the site elements included in the target site cut face, and the graphic of each site element is an independent SVG element.

Taking the case shown in FIG. 5 as an example, in the cut face display mode, the SVG of the cut face 5 is displayed on the seat display interface, and the site elements included in the cut face 5 are displayed in the SVG (floor 2, floor 1, stand 6, stand 5, stand, stand 4, stage).

By means of entering the cut face display mode, a user is able to intuitively view the specific spatial layout of the selected target cut face, and based on the spatial dimension information such as the height of the visualization and the angle of view; perform corresponding operations to obtain the corresponding seat distribution for seat selection.

In one example, at least one site element is included in the target site cut face. The site elements include at least one of a floor, a stand, a stage, and a seat. Correspondingly, the seat display method provided in this embodiment as shown in FIG. 7 further includes the steps S2310-S2320.

Step S2310, in the cut face display mode, receiving an element selection operation performed by the user in the interface area of the target site cut face in the seat selection interface, and determining the target site element selected by the user.

The element selection operation may be a selection operation performed on the corresponding site element graphic, such as clicking, pressing, and the like. When the user performs the element selection operation, the target site element selected by the user can be determined. For example, as shown in FIG. 5, when a user clicks the floor 2 image or the stand 5 image in the SVG of the cut face 5 by finger, the target site element is correspondingly determined to be the floor 2 or the stand 5.

Step S2320, displaying the seat layout of the target site element in the planar display mode for the user to select a corresponding seat. For example, when the target site element is the floor 2, correspondingly, in the planar display mode, the seat layout on the floor 2 in the space of the target site corresponding to the cut face 5 is displayed in a planar view form (for example, SVG); while when the target site element is the stand 5, the seat layout in the stand 5 in the space of the target site corresponding to the cut face 5 is displayed in a planar view form (for example, SVG); thus the user can select a seat that meets his or her needs in the displayed seat layout.

### Seating Display Device

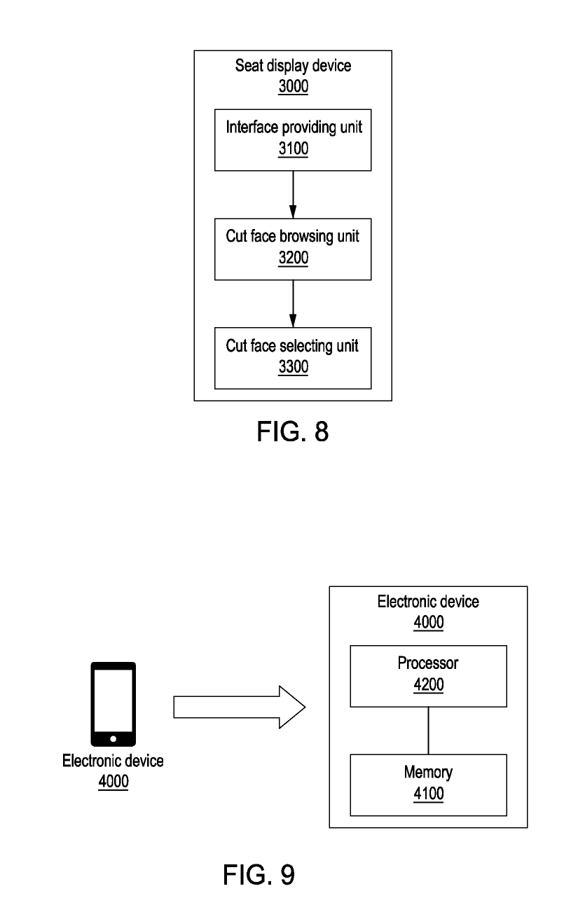

In this embodiment, a seating display device 3000 is further provided, as shown in FIG. 8, comprising: an interface providing unit 3100, a cut face browsing unit 3200, and a cut face selecting unit 3300 for implementing the seat display method provided in is example, which will not be repeated herein.

The interface providing unit 3100 is used for providing a seat display interface and displaying a target site in a planar display mode.

The cut face browsing unit 3200 is used for receiving a cut face viewing operation performed by a user on the seat display interface, and displaying a plurality of site cut faces included in a target site in the cut face browsing mode for the user to browse and select a target site cut face, wherein, the site cut face is a two-dimensional plane obtained by dividing a three-dimensional view of a corresponding site.

Optionally, the cut face browsing unit 3200 is further used for:
obtaining a site three-dimensional view of the target site;
according to a preset cutting rule, cutting the site three-dimensional view to obtain a plurality of candidate site cut faces;
selecting candidate site cut faces that meet a preset effective cut face condition, so as to obtain the plurality of site cut faces of the target site.

Optionally, the cutting rule is to cut a corresponding three-dimensional view into a predetermined number of cut faces at equal intervals in a specific dimension direction;
the effective cut face condition is that the candidate site cut faces comprise at least one site element different from the other candidate site cut faces, and the site element comprises at least one of a floor, a stand, and a stage.

Optionally, the cut face browsing unit 3200 is further used for:
generating a corresponding site cut face linked list according to a relative spatial position of each of the site cut faces in the target site;
wherein the site cut face linked list comprises a linked list order of each of the site cut face, and the linked list order corresponds to the relative spatial position.

Optionally, the cut face browsing unit 3200 is further used for:
displaying the site cut faces associated with the cut face viewing operation through the seat display interface;
providing a cut face browsing control element through the seat display interface to receive the cut face browsing operation;
locating a site cut face corresponding to the cut face viewing operation, when the located site cut face is inconsistent with the site cut face displayed by the current seat display interface, switching to display the located site cut face.

Optionally, the cut face browsing control element comprises a cut face selection control element, and the cut face selection control element is set according to the acquired site cut face linked list, wherein the site cut face linked list comprises the linked list order of each of the site cut faces, and the linked list order corresponds to the relative spatial position of the site cut face in the corresponding site; the cut face browsing unit 3200 is further used for:
locating in the site switch linked list to obtain the corresponding site cut face according to the linked list order corresponding to the operation position of the cut face browsing operation on the cut face selection control element.

Optionally, the cut face browsing unit 3200 is further used for:
when the cut face browsing operation ends on the cut face selection control element, locating in the site switch linked list to obtain the corresponding target site cut face according to the linked list order corresponding to the operation position at the operation end, and entering the cut face display mode.

The cut face selecting unit 3300 is used for receiving a cut face selection operation performed by a user on the seat display interface, and displaying a corresponding target site cut face in a cut face display mode, so as to display a corresponding seat layout after the user performing the operation.

Optionally, the target site cut face comprises at least one site element, and the site element comprises at least one of a floor, a stand, a stage, and a seat; and the cut face selecting unit 3300 is further used for: in the cut face display mode, receiving an element selection operation performed by a user in an interface area for displaying the target site cut face on a seat selection interface, and determining a target site element selected by the user; Displaying a seat layout of the target site element in the planar display mode for the user to select a corresponding seat.

Optionally, the planar display mode is to display the site elements included in the corresponding planar space in the planar view mode, the site element comprises at least one of a floor, a stand, and a stage; the cut face browsing mode is to display the site elements included in the plurality of site cut faces in a planar view form in a rotating manner; and the cut face display mode is to display the site elements included in the target site cut face in a planar view form; and/or The cut face viewing operation is a moving operation performed on a cut face viewing control element provided by the seat display interface.

A person skilled in the art will appreciate that the seat display device 3000 can be implemented in a variety of ways. For example, the seat display device 3000 can be implemented by an instruction configuration processor. For example, the instructions can be stored in a ROM, and when the device is booted, the instructions are read from the ROM into the programmable device to implement the seat display device 3000. For example, the seat display device 3000 can be fixed into a dedicated device (for example, an ASIC). The seat display device 3000 can be divided into mutually independent units or can be implemented by combining them together. The seat display device 3000 may be implemented by one of the various ways of implementation as described above, or may be implemented by a combination of two or more of the various ways of implementation as described above.

In one example, the seat display device 3000 can be a ticketing application that provides a seat reservation service, for example, a ticketing APP that can be installed on a mobile phone to run.

### Electronic Device

In this example, an electronic device 4000 is provided, as shown in FIG. 9, comprising:
a display device 4100, for display a human machine interaction interface;
a memory 4200, for storing executable instructions; and
a processor, for operating, according to the control of the executable instruction, the electronic device to perform any one of the seat display methods provided in this example.

Embodiments of the present invention have been described above with reference to the accompanying drawings. According to an embodiment of the present invention, a seat display method, device, and equipment are provided. A plurality of site cut faces included in the target site are displayed through a seat display interface for a user to browse and select the target site cut faces meeting the user's requirements, and the corresponding seat layout is displayed for the user to select. In the case of limited display performance, a two-dimensional planar form is used to quickly and intuitively display the three-dimensional spatial layout of the target site to the user, so that the three-dimensional spatial dimension information of the target site is visualized, the visibility of the seat display is optimized, and the user experience is improved.

The present invention can be implemented in a system, method and/or computer program product. The computer program product can comprise a computer readable storage medium having computer readable program instructions embodied thereon for causing a processor to implement various aspects of the present invention.

The computer readable storage medium can be a tangible device that can hold and store the instructions used by an instruction execution device. The computer readable storage medium can be, for example, but is not limited to, an electrical storage device, a magnetic storage device, an optical storage device, an electromagnetic storage device, a semiconductor storage device, or any suitable combination of the foregoing. More specific examples (non-exhaustive list) of computer readable storage media include: portable computer disks, hard disks, random access memory (RAM), read only memory (ROM), erasable programmable read only memory (EPROM or flash memory), static random access memory (SRAM), portable compact disk read only memory (CD-ROM), digital versatile disk (DVD), memory sticks, floppy disks, mechanical encoding devices, a punched card or a raised structure in a groove on which an instruction is stored, and any suitable combination of the above. The computer readable storage medium as used herein is not to be interpreted as a transient signal itself, such as a radio wave or other freely propagating electromagnetic wave, an electromagnetic wave propagating through a waveguide or other transmission medium (for example, a light pulse through a fiber optic cable), or an electrical signal transmitted through a wire.

The computer readable program instructions described herein can be downloaded from a computer readable storage medium to various computing/processing devices or downloaded to an external computer or external storage device over a network, such as the Internet, a local area network, a wide area network, and/or a wireless network. The network may include copper transmission cables, fiber optic transmissions, wireless transmissions, routers, firewalls, switches, gateway computers, and/or edge servers. A network adapter card or network interface in each computing/processing device receives computer readable program instructions from the network and forwards the computer readable program instructions for storage in a computer readable storage medium in each computing/processing device.

The computer program instructions for performing the operations of the present invention may be assembly instructions, instruction set architecture (ISA) instructions, machine instructions, machine related instructions, microcode, firmware instructions, state setting data, or the source code or object code written in any combination of one or more programming languages, including object oriented programming languages—such as Smalltalk, C++, etc., and conventional procedural programming languages—such as the “C” language or a similar programming language. The computer readable program instructions can be executed entirely on the user's computer, partly on the user's computer, as a stand-alone software package, partly on the user's computer and partly on a remote computer, or entirely on a remote computer or server. In the case of a remote computer, the remote computer can be connected to the user's computer through any kind of network, including a local area network (LAN) or wide area network (WAN), or can be connected to an external computer (for example, using an Internet service provider to access the Internet). In some embodiments, a customized electronic circuit can be customized by utilizing state information of computer readable program instructions, such as a programmable logic circuit, a field programmable gate array (FPGA), or a programmable logic array (PLA). Computer readable program instructions are executed to implement various aspects of the present invention.

Aspects of the present invention are described herein with reference to flowchart illustrations and/or block diagrams of methods, apparatus, and computer program products according to certain embodiments of the present invention. It will be understood that each block of the flowchart illustrations and/or block diagrams, and combinations of blocks in the flowcharts and/or block diagrams can be implemented by computer readable program instructions.

The computer readable program instructions can be provided to a general purpose computer, a special purpose computer, or a processor of other programmable data processing apparatus to produce a machine, such that when the instructions are executed by a processor of a computer or other programmable data processing apparatus, a device or means for implementing the functions/actions specified in one or more of the blocks of the flowcharts and/or block diagrams is generated. The computer readable program instructions can also be stored in a computer readable storage medium that causes the computer, programmable data processing device, and/or other device to operate in a particular manner. Thus, a computer readable medium having instructions stored thereon includes an article of manufacture that includes instructions for implementing various aspects of the functions/acts recited in one or more of the flowcharts.

Computer readable program instructions can also be loaded onto a computer, other programmable data processing device, or other device to perform a series of operational steps on a computer, other programmable data processing device or other device to produce a computer-implemented process. Thus, instructions executed on a computer, other programmable data processing apparatus, or other device implement the functions/actions recited in one or more blocks of the flowcharts and/or block diagram.

The flowchart and block diagrams in the drawings illustrate the architecture, functionality and operation of possible implementations of systems, methods and computer program products according to various embodiments of the invention. In this regard, each block in the flowchart or block diagram can represent a module, a program segment, or a portion of an instruction that includes one or more executable instructions. In some alternative implementations, the functions noted in the blocks may also occur in a different order than those illustrated in the drawings. For example, two consecutive blocks may be executed substantially in parallel, or sometimes they may be executed in the reverse order, depending upon the functionality involved. It is also noted that each block of the block diagrams and/or flowcharts, and combinations of blocks in the block diagrams and/or flowcharts, can be implemented in a dedicated hardware-based system that performs the specified function or action, or it can be implemented by a combination of dedicated hardware and computer instructions. It is well known to a person skilled in the art that implementation by hardware, implementation by software, and implementation by a combination of software and hardware are all equivalent.

The embodiments of the present invention have been described above, and the foregoing description is illustrative, not limiting, and not limited to the disclosed embodiments. Numerous modifications and changes will be apparent to a person skilled in the art without departing from the scope of the present invention. The choice of terms used herein is intended to best explain the principles, practical applications, or technical improvements in these embodiments, or make a person of ordinary skill in the art understand the various embodiments disclosed herein. The scope of the invention is defined by the appended claims.

What is claimed is:

1. A computer implemented method for selecting and displaying a seat, comprising:
providing a seat display interface and displaying a target site in a planar display mode;
receiving a cut face viewing operation performed by a user on the seat display interface and displaying a plurality of site cut faces of the target site in a cut face browsing mode for the user,
wherein the site cut face is a two-dimensional plane obtained by cutting a site three-dimensional view of a corresponding site; and
receiving a cut face selecting operation performed by the user on the seat display interface in the cut face browsing mode and displaying a corresponding target site cut face in the cut face display mode for displaying a corresponding seat layout following the operation of the user.

2. The method according to claim 1, wherein the method further comprises a step of obtaining the site cut face of the target site;
obtaining a site three-dimensional view of the target site;
according to a preset cutting rule, cutting the site three-dimensional view to obtain a plurality of candidate site cut faces; and
selecting candidate site cut faces that meet a preset effective cut face condition so as to obtain the plurality of site cut faces of the target site.

3. The method according to claim 2, wherein
the cutting rule is to cut a corresponding three-dimensional view into a predetermined number of cut faces at equal intervals in a specific dimension direction;
the effective cut face condition is that the candidate site cut faces comprising at least one site element different from the other candidate site cut faces, and the site element comprising at least one of a floor, a stand, and a stage; and
the step of obtaining the site cut faces of the target site further comprising:
generating a corresponding site cut face linked list according to a relative spatial position of each of the site cut faces in the target site,
wherein the site cut face linked list comprises a linked list order of each of the site cut faces, and the linked list order corresponds to the relative spatial position.

4. The method according to claim 1, wherein the step of displaying the plurality of site cut faces of the target site in a cut face browsing mode comprises:
displaying the site cut faces associated with the cut face viewing operation through the seat display interface;
providing a cut face browsing control element through the seat display interface to receive the cut face browsing mode; and
locating a site cut face corresponding to the cut face viewing operation, when the located site cut face is inconsistent with the site cut face displayed by the current seat display interface, switching to display the located site cut face.

5. The method according to claim 4, wherein
the cut face browsing control element comprises a cut face selection control element, and the cut face selection control element is set according to the acquired site cut face linked list, wherein the site cut face linked list comprises the linked list order of each of the site cut faces, and the linked list order corresponds to the relative spatial position of the site cut face in the corresponding site; and
the step of locating the site cut face corresponding to the cut face browsing operation comprising:
locating in the site switch linked list to obtain the corresponding site cut face according to the linked list order corresponding to the operation position of the cut face browsing operation on the cut face selection control element.

6. The method according to claim 5, wherein the method further comprises:
when the cut face browsing operation ends on the cut face selection control element, locating in the site switch linked list to obtain the corresponding target site cut face according to the linked list order corresponding to the operation position at the operation end, and entering the cut face display mode.

7. The method according to claim 1, wherein
the target site cut face comprises at least one site element, and the site element comprises at least one of a floor, a stand, a stage, and a seat;
the method further comprising:
in the cut face display mode, receiving an element selection operation performed by a user in an interface area for displaying the target site cut face on a seat selection interface, and determining a target site element selected by the user; and
displaying a seat layout of the target site element in the planar display mode for the user to select a corresponding seat.

8. The method according to claim 1, wherein
the planar display mode is to display the site elements included in the corresponding planar space in the planar view mode, the site element comprises at least one of a floor, a stand, and a stage; the cut face browsing mode is to display the site elements included in the plurality of site cut faces in a planar view form in a rotating manner; and the cut face display mode is to display the site elements included in the target site cut face in a planar view form; and
the cut face viewing operation is a moving operation performed on a cut face viewing control element provided by the seat display interface.

9. A seating at a venue display device comprising:
an interface providing unit for providing a seat display interface and displaying a target site in a planar display mode;
a cut face browsing unit for receiving a cut face viewing operation performed by a user on the seat display interface, and displaying a plurality of site cut faces included in a target site in the cut face browsing mode for the user to browse and select a target site cut face,
wherein the site cut face is a two-dimensional plane obtained by dividing a three-dimensional view of a corresponding site; and
a cut face selecting unit for receiving a cut face selection operation performed by a user on the seat display interface, and displaying a corresponding target site cut face in a cut face display mode, so as to display a corresponding seat layout after the user performing the operation.

10. An electronic device comprising:
a screen for displaying an image;
a memory for storing executable instructions; and
a processor for operating the electronic device to perform the seat selection method of claim 1 and display a seat layout image comprising a selected seat based on the executable instructions in memory.

11. A computer implemented method for selecting and displaying seats at a venue, comprising:
generating a plurality of 2-dimensional images of seats at a venue by taking cross-sectional views of 3-dimensional images comprising the spatial arrangement of seats at the venue;
selecting a seat that satisfies a selection criteria for a selectable seat, based on the 2-dimensional seating images at the venue; and
displaying a 3-dimensional image of the venue that identifies the selected seat.

12. The method of claim 11, wherein the 3-dimensional image of the venue comprises selectable seats in the physical space layout of the venue.

13. The method of claim 12, wherein the plurality of 2-dimensional images are generated based on a predetermined criteria for generating 2-dimensional images of selectable seats from the 3-dimensional images of seats at the venue.

14. The method of claim 13, the predetermined criteria comprises a rule to generate a pre-determined number of cross-sections of the seats are at equal intervals from each other in a specific dimensional direction of the 3-dimensional image of the venue, wherein each 2-dimensional image is distinguishable from each other and wherein each image displays a least one of a floor, a stand, and a stage with a selectable seat.

15. The method of claim 14, further comprising displaying 2-dimensional images of seats that satisfy the selection criteria for selectable seats at the venue.

16. The method of claim 15, wherein the venue comprises seats located on multi-story seating levels.

17. The method of claim 16, wherein the selection criteria comprises selecting a seat based on a 2-dimensional image comprising a floor, a stand and a stage or a combination thereof at the venue.

18. The method of claim 17, wherein a selected seat is shown relative to all seats at in a 3-dimensional image of the venue.

19. The method of claim 18, wherein the images of selected seats at the venue are displayed on 3-dimensional image on a screen of a computer.

20. The method of claim 19, wherein the computer comprises a computer network.
